(19) United States
(12) Patent Application Publication
(10) Pub. No.: US 2021/0023985 A1
(43) Pub. Date: Jan. 28, 2021

(54) SYSTEM AND METHOD TO INDICATE A VEHICLE STATUS

(71) Applicant: GENERAL MOTORS LLC, Detroit, MI (US)

(72) Inventor: Anthony Stadnyk, Rochester Hills, MI (US)

(21) Appl. No.: 16/519,639

(22) Filed: Jul. 23, 2019

(51) Int. Cl. B60Q 1/52

(52) U.S. Cl. CPC B60Q 1/52

(57) ABSTRACT

One general aspect includes a method to exhibit a vehicle status, the method including: receiving a signal that the vehicle status be exhibited at a vehicle; and based on the signal, generating a vehicle status indicator that corresponds to a status of the vehicle, the vehicle status indicator being a visual cue visible in an environment surrounding the vehicle, where the vehicle status indicator is generated by an antenna module located on a portion of the vehicle.

People generally take in many visual cues as part of the driving experience. They use these cues to predict the behavior and understand the operating status of nearby motorists. However, status indicators currently installed on vehicles are very limited in the information that they can display. For example, blinking headlamps cannot tell pedestrians and fellow drivers that the vehicle is stolen and being driven by a criminal, nor can these headlamps let others know the vehicle is coming from a potentially hazardous area, nor can they properly signal that an emergency situation is occurring within the vehicle's interior cabin. Therefore, to enhance the safety of those around a vehicle as well as those within the vehicle, it is desirable to provide a system and method to indicate a vehicle's status in various unique situations. Moreover, other desirable features and characteristics of the present invention will become apparent from the subsequent detailed description of the invention and the appended claims, taken in conjunction with the accompanying drawings and this background of the invention.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method to exhibit a vehicle status, the method including: receiving a signal that the vehicle status be exhibited at a vehicle; and based on the signal, generating a vehicle status indicator that corresponds to a status of the vehicle, the vehicle status indicator being a visual cue visible in an environment surrounding the vehicle, where the vehicle status indicator is generated by an antenna module located on a portion of the vehicle. Other embodiments of this aspect include corresponding computer systems, apparatus, and computer programs recorded on one or more computer storage devices, each configured to perform the actions of the methods.

Implementations may include one or more of the following features. The method where the antenna module includes one or more lights and the vehicle status indicator is provided via the light being illuminated. The method where the status of the vehicle corresponds to a color of the one or more lights while being illuminated. The method where the vehicle is an autonomous vehicle and the signal is automatically provided when the vehicle is located within one or more geographic boundaries. The method where the signal is provided by a button located in an interior of the vehicle. The method where the signal is provided by a mobile computing device located remotely from the vehicle. The method where the signal is provided by a remote facility after the remote facility receives information regarding the vehicle being stolen. Implementations of the described techniques may include hardware, a method or process, or computer software on a computer-accessible medium.

One general aspect includes a system to exhibit a vehicle status, the system including: a memory configured to include one or more executable instructions and a processor configured to execute the executable instructions, where the executable instructions enable the processor to carry out the following steps: receiving a signal that the vehicle status be exhibited at a vehicle; and based on the signal, generating a vehicle status indicator that corresponds to a status of the vehicle, the vehicle status indicator being a visual cue visible in an environment surrounding the vehicle, where the vehicle status indicator is generated by an antenna module located on a portion of the vehicle. Other embodiments of this aspect include corresponding computer systems, apparatus, and computer programs recorded on one or more computer storage devices, each configured to perform the actions of the methods.

Implementations may include one or more of the following features. The system where the antenna module includes one or more lights and the vehicle status indicator is provided via the one or more lights being illuminated. The system where the status of the vehicle corresponds to a color of the one or more lights while being illuminated. The system where the vehicle is an autonomous vehicle and the signal is automatically provided when the vehicle is located within one or more geographic boundaries. The system where the signal is provided by a button located in an interior of the vehicle. The system where the signal is provided by a mobile computing device located remotely from the vehicle. The system where the signal is provided by a remote facility after the remote facility receives information regarding the vehicle being stolen. Implementations of the described techniques may include hardware, a method or process, or computer software on a computer-accessible medium.

One general aspect includes a non-transitory and machine-readable medium having stored thereon executable instructions adapted to exhibit a vehicle status, which when provided to a processor and executed thereby, causes the processor to carry out the following steps: receiving a signal that the vehicle status be exhibited at a vehicle; and based on the signal, generating a vehicle status indicator that corresponds to a status of the vehicle, the vehicle status indicator being a visual cue visible in an environment surrounding the vehicle, where the vehicle status indicator is generated by an antenna module located on a portion of the vehicle. Other embodiments of this aspect include corresponding computer systems, apparatus, and computer programs recorded on one or more computer storage devices, each configured to perform the actions of the methods.

Implementations may include one or more of the following features. The non-transitory and machine-readable medium where the antenna module includes one or more lights and the vehicle status indicator is provided via the one or more lights being illuminated. The non-transitory and machine-readable medium where the status of the vehicle corresponds to a color of the one or more lights while being illuminated. The non-transitory and machine-readable medium where the vehicle is an autonomous vehicle and the signal is automatically provided when the vehicle is located within one or more geographic boundaries. The non-transitory and machine-readable medium where the signal is provided by a mobile computing device located remotely from the vehicle. The non-transitory and machine-readable medium where the signal is provided by a remote facility after the remote facility receives information regarding the vehicle being stolen. Implementations of the described techniques may include hardware, a method or process, or computer software on a computer-accessible medium.

The above features and advantages and other features and advantages of the present teachings are readily apparent from the following detailed description for carrying out the teachings when taken in connection with the accompanying drawings.

### BRIEF DESCRIPTION OF THE DRAWINGS

The disclosed examples will hereinafter be described in conjunction with the following drawing figures, wherein like numerals denote like elements, and wherein:

FIG. 1 is a block diagram depicting an exemplary embodiment of a communications system capable of utilizing the system and method disclosed herein;

FIG. 2 is a perspective view of an embodiment of a vehicle depicting an exemplary aspect of the system and method disclosed herein;

FIG. 3A is a perspective view of an embodiment of an antenna module depicting an exemplary aspect of the system and method disclosed herein;

FIG. 3B is a perspective view of another embodiment of the antenna module depicting an exemplary aspect of the system and method disclosed herein;

FIG. 3C is a perspective view of another embodiment of the antenna module depicting an exemplary aspect of the system and method disclosed herein;

FIG. 4 is a flow chart for an exemplary methodology to exhibit a vehicle status according to one aspect of the system and method presented herein;

FIG. 5 is a flow chart for an exemplary methodology to exhibit a vehicle status according to one aspect of the system and method presented herein;

FIG. 6 is a flow chart for an exemplary methodology to exhibit a vehicle status according to one aspect of the system and method presented herein; and

FIG. 7 is a flow chart for an exemplary methodology to exhibit a vehicle status according to one aspect of the system and method presented herein.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present system and/or method. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The following detailed description is merely exemplary in nature and is not intended to limit the application and uses. Furthermore, there is no intention to be bound by any expressed or implied theory presented in the preceding background and brief summary or the following detailed description. As used herein, the term module refers to an application specific integrated circuit (ASIC), an electronic circuit, a processor (shared, dedicated, or group) and memory that executes one or more software or firmware programs or code segments, a combinational logic circuit, and/or other suitable components that provide the described functionality.

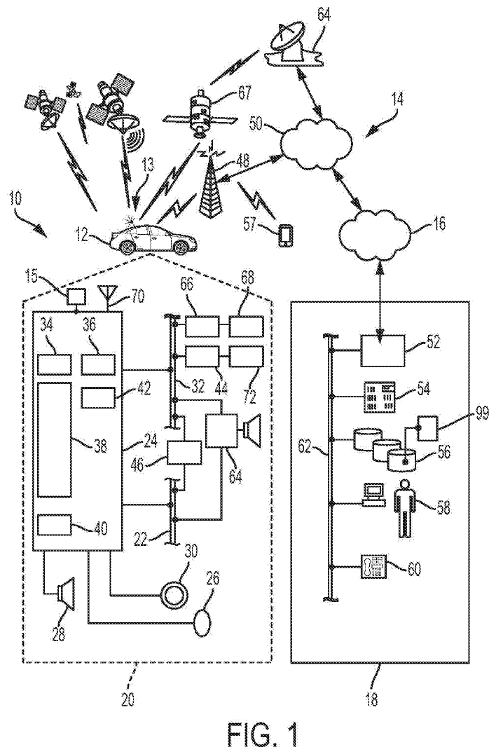

As shown in FIG. 1, there is shown a non-limiting example of a communication system 10 that may be used together with examples of the system disclosed herein and/or to implement examples of the methods disclosed herein. Communication system 10 generally includes a vehicle 12, a wireless carrier system 14, a land network 16, and a data center 18 (i.e., the backend). It should be appreciated that the overall architecture, setup, and operation, as well as the individual components of the illustrated system are merely exemplary and that differently configured communication systems may also be utilized to implement the examples of the system and/or method disclosed herein. Thus, the following paragraphs, which provide a brief overview of the illustrated communication system 10, are not intended to be limiting.

Vehicle 12 may be any type of manually operated or autonomous vehicle such as a motorcycle, car, sports utility vehicle (SUV), truck, bus, bicycle, recreational vehicle (RV), construction vehicle (e.g., bulldozer), train, trolley, marine vessel (e.g., a boat), aircraft (e.g., airplane, helicopter, etc.), amusement park vehicle, farm equipment, golf cart, etc., and is equipped with suitable hardware and software that enables it to communicate over communication system 10. In certain embodiments, vehicle 12 may include a power train system with multiple generally known torque-generating devices including, for example, an engine. The engine may be an internal combustion engine that uses one or more cylinders to combust fuel, such as gasoline, in order to propel vehicle 12. The power train system may alternatively include numerous electric motors or traction motors that convert electrical energy into mechanical energy for propulsion of vehicle 12.

Some of the fundamental vehicle hardware 20 is shown generally in FIG. 1 including a telematics unit 24, a microphone 26, speaker 28, and buttons and/or controls 30 connected to telematics unit 24. Operatively coupled to telematics unit 24 is a network connection or vehicle bus 32. Examples of suitable network connections include a controller area network (CAN), WIFI, Bluetooth, and Bluetooth Low Energy, a media oriented system transfer (MOST), a local interconnection network (LIN), a local area network (LAN), and other appropriate connections such as Ethernet or those that conform with known ISO (International Organization for Standardization), SAE (Society of Automotive Engineers), and/or IEEE (Institute of Electrical and Electronics Engineers) standards and specifications, to name a few.

The telematics unit 24 can be an OEM-installed (embedded) or aftermarket communication system which provides a variety of services through its communications with the data center 18, and generally includes an electronic processing device 38, one or more types of electronic memory 40, a cellular chipset/component 34, wireless modem 36, an antenna system 70 including one or more antennas, antenna module 13 (discussed below), and a navigation unit containing a GPS chipset/component 42 capable of communicating location information via a GPS satellite system 67. GPS component 42 thus receives coordinate signals from a constellation of GPS satellites 67. From these signals, the GPS component 42 can determine vehicle position, which may be used for providing navigation and other position-related services to the vehicle operator. Navigation information can be presented on a display of telematics unit 24 (or other display within the vehicle) or can be presented verbally such as is done when supplying turn-by-turn navigation. The navigation services can be provided using a dedicated in-vehicle navigation module (that can be part of GPS component 42), or some or all navigation services can be done via telematics unit 24, wherein the location coordinate information is sent to a remote location for purposes of providing the vehicle with navigation maps, map annotations, route calculations, and the like.

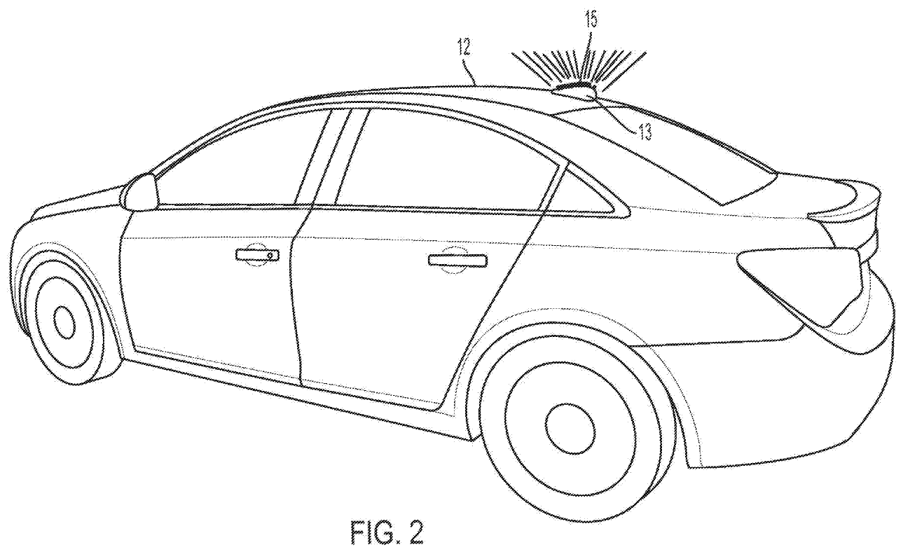

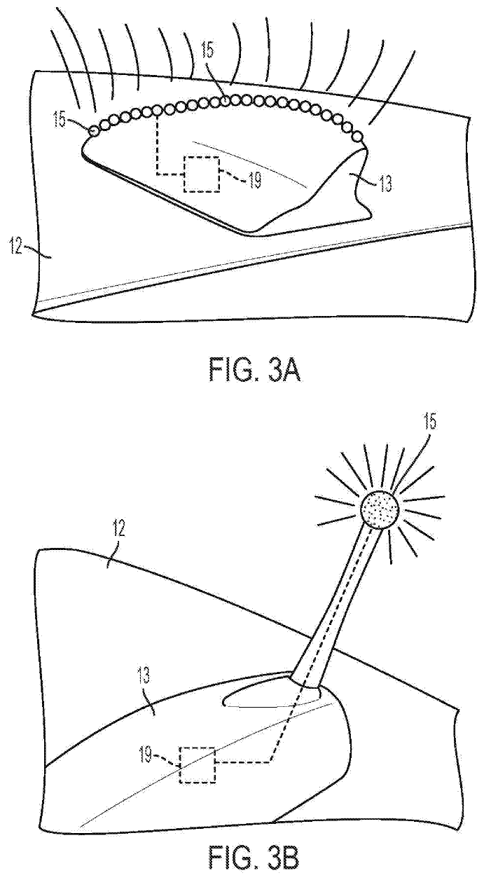

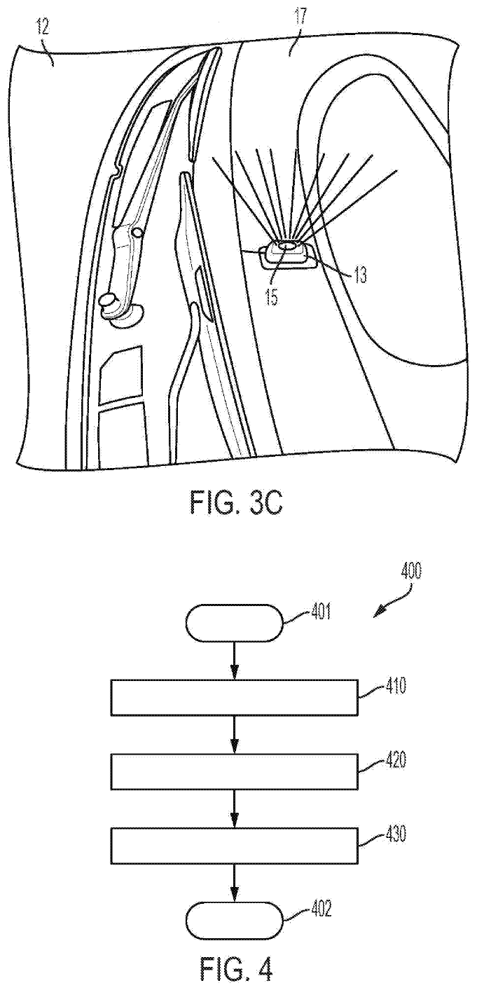

With additional reference to FIG. 2, the antenna module 13 is an electronic device that houses the one or more antennas 70 as well as the GPS chipset/component 42. As shown, the antenna module 13 can be installed on the body of vehicle 12, for example, on the vehicle's roof or on the vehicle's dashboard (e.g., via adhesives, fasteners, welding, etc.). Moreover, one or more lights 15 are installed on the exterior of antenna module 13. The light(s) 15 are operatively connected to telematics unit 24 and can be, for example, light emitting diodes (LED) of a brightness easily seen in daylight. The light(s) 15 may also emit various different colors depending on the circumstances involving their illumination, for example, the light(s) may emit a white, green, red, or yellow color. As can be understood, antenna module 13 and light(s) 15 can generate a visual cue used to communicate information to audiences found in the environment surrounding the vehicle 12. Thus, each color illuminated by the light(s) can be associated with a different meaning for which the light was activated. For example, illuminating a white color can be associated with the identification of the vehicle's location, a yellow color can be associated with a vehicle emergency occurring within or nearby the vehicle 12, a red color can be associated with a stolen vehicle, a green color can indicate the vehicle is self driving in an autonomous vehicle mode and is coming from or going to a potentially hazardous location. An independent power source 19 can also be embedded in antenna module 13 and operatively connected to light(s) 15. As such, if the vehicle 12 loses power, light(s) may still be activated to produce the vehicle status indicator. Referring to FIG. 3A, antenna module 13 can be embodied as a shark-fin antenna with a series of light(s) 15 embedded along the antenna's spine. Referring to FIG. 3B, the antenna module 13 can be of the dipole variety and the light 15 may be located at the tip of the body of antenna 70. Referring to FIG. 3C, antenna module 13 can also be installed on the dashboard 17 of vehicle 12 and the light(s) 15 can be installed on the flat surface of the body of antenna module 13.

Returning to FIG. 1, the telematics unit 24 may provide various services including: turn-by-turn directions, map-based directions, and other navigation-related services provided in conjunction with the GPS component 42; airbag deployment notification and other emergency or roadside assistance-related services provided in connection with various crash and/or collision sensor interface modules 66 and collision sensors 68 located throughout the vehicle and/or infotainment-related services where music, internet web pages, movies, television programs, videogames, and/or other content are downloaded by an infotainment center 46 operatively connected to the telematics unit 24 via vehicle bus 32 and audio bus 22. In one example, downloaded content is stored for current or later playback. It should be understood that an independent infotainment center 46 may be located at each vehicle seat within vehicle 12, such that each vehicle occupant has control of their own infotainment-related services. The above-listed services are by no means an exhaustive list of all the capabilities of telematics unit 24 but are simply an illustration of some of the services telematics unit 24 may be capable of offering. It is anticipated that telematics unit 24 may include a number of additional components in addition to and/or different components from those listed above.

Vehicle communications may use radio transmissions to establish a communication channel (voice channel and/or data channel) with wireless carrier system 14 so that both voice and/or data transmissions can be sent and received over the channel. Vehicle communications are enabled via the cellular component 34 for voice communications and the wireless modem 36 for data transmission. Any suitable encoding or modulation technique may be used with the present examples, including digital transmission technologies, such as TDMA (time division multiple access), CDMA (code division multiple access), W-CDMA (wideband CDMA), FDMA (frequency division multiple access), OFDMA (orthogonal frequency division multiple access), etc. To accomplish this effect, dual mode antenna 70 services the GPS component 42 and the cellular component 34.

Microphone 26 provides the driver or other vehicle occupant with a means for inputting verbal or other auditory commands, and can be equipped with an embedded voice processing unit utilizing a human/machine interface (HMI) technology known in the art. Conversely, speaker 28 provides audible output to one or more vehicle occupants and can be either a stand-alone speaker specifically dedicated for use with the telematics unit 24 or can be part of a vehicle audio component 64. In either event, microphone 26 and speaker 28 enable vehicle hardware 20 and data center 18 to communicate with the occupants through audible speech. Moreover, microphone 26 and speaker 28 can be considered one of multiple microphones 26 and speakers 28 installed within vehicle 12, each of which being located at a respective vehicle seat within vehicle 12. The vehicle hardware also includes one or more buttons and/or controls 30 for enabling a vehicle occupant to activate or engage one or more of the vehicle hardware components 20. For example, one of the buttons and/or controls 30 can be an electronic pushbutton used to initiate voice communication with data center 18 (whether it be a human such as advisor 58 or an automated call response system). In another example, one of the buttons and/or controls 30 can be used to initiate emergency services. These one or more buttons and/or controls 30 can be located in the interior of vehicle 12.

The audio component 64 is operatively connected to the vehicle bus 32 and the audio bus 22. The audio component 64 receives analog information, rendering it as sound, via the audio bus 22. Digital information is received via the vehicle bus 32. The audio component 64 provides amplitude modulated (AM) and frequency modulated (FM) radio, satellite radio, compact disc (CD), digital video disc (DVD), and multimedia functionality independent of the infotainment center 46. Audio component 64 may contain a speaker system (having at least one speaker assigned to each vehicle seat) or may utilize speaker 28 via arbitration on vehicle bus 32 and/or audio bus 22.

The vehicle crash and/or collision detection sensor interface 66 is operatively connected to the vehicle bus 32. The collision sensors 68 provide information to telematics unit 24 via the crash and/or collision detection sensor interface 66 regarding the severity of a vehicle collision, such as the angle of impact and the amount of force sustained.

Vehicle sensors 72, connected to various vehicle sensor modules 44 (VSMs) in the form of electronic hardware components located throughout vehicle 12 and use the sensed input to perform diagnostic, monitoring, control, reporting and/or other functions. Each of the VSMs 44 is preferably connected by vehicle bus 32 to the other VSMs, as well as to the telematics unit 24, and can be programmed to run vehicle system and subsystem diagnostic tests. As examples, one VSM 44 can be an engine control module (ECM) that controls various aspects of engine operation such as fuel ignition and ignition timing. According to one embodiment, the ECM is equipped with on-board diagnostic (OBD) features that provide myriad real-time data, such as that received from various sensors including vehicle emissions sensors, fuel diagnostics sensors, and vehicle oil pressure sensors as well as provide a standardized series of diagnostic trouble codes (DTCs) which allow a technician to rapidly identify and remedy malfunctions within the vehicle. VSM 44 can similarly be a powertrain control module (PCM) that regulates operation of one or more components of the powertrain system. Another VSM 44 can be a body control module (BCM) that monitors and governs various electrical components located throughout the vehicle body like the vehicle's power door locks, horn system, power windows, HVAC system (air conditioner and heating), ambient lighting within the vehicle interior, tire pressure, one or more seat weight sensors, lighting system, engine ignition, vehicle seat adjustment and heating, mirrors, and headlights. Furthermore, as can be appreciated by skilled artisans, the above-mentioned VSMs are only examples of some of the modules that may be used in vehicle 12, as numerous others are also possible.

A passive entry passive start (PEPS) module, for instance, is another of the numerous of VSMs and provides passive detection of the absence or presence of a passive physical key or a virtual vehicle key. When the passive physical key approaches, the PEPS module can determine if the passive physical key is authentic as belonging to the vehicle 12. The PEPS can likewise use authentication information received from data center 18 to determine if a mobile computing device 57 with virtual vehicle key is authorized/authentic to vehicle 12. If the virtual vehicle key is deemed authentic, the PEPS can send a command to BCM 44 permitting access to the vehicle 12.

Wireless carrier system 14 may be a cellular telephone system or any other suitable wireless system that transmits signals between the vehicle hardware 20 and land network 16. According to an example, wireless carrier system 14 includes one or more cell towers 48 (only one shown), one or more cellular network infrastructures (CNI) (not shown), as well as any other networking components required to connect wireless carrier system 14 with land network 16.

Land network 16 can be a conventional land-based telecommunications network connected to one or more landline telephones, and that connects wireless carrier system 14 to data center 18. For example, land network 16 can include a public switched telephone network (PSTN) and/or an Internet protocol (IP) network, as is appreciated by those skilled in the art. Of course, one or more segments of the land network 16 can be implemented in the form of a standard wired network, a fiber or other optical network, a cable network, other wireless networks such as wireless local networks (WLANs) or networks providing broadband wireless access (BWA), or any combination thereof.

As revealed above, one of the networked devices that can directly or indirectly communicate with the telematics unit 24 is a mobile computing device 57, such as (but not limited to) a smart phone, personal laptop computer or tablet computer having two-way communication capabilities, a wearable computer such as (but not limited to) a smart watch or glasses, or any suitable combinations thereof. The mobile computing device 57 can include computer processing capability, a mobile memory, and a transceiver capable of communicating with remote locations (e.g., data center 18), amongst other features. Examples of the mobile computing device 57 include the IPHONE™ and APPLE WATCH™ each being manufactured by Apple, Inc., and the GALAXY™ smart phone manufactured by Samsung Electronics Company as well as others.

Mobile device 57 may be used inside or outside of a vehicle and may be coupled to the vehicle by wire or wirelessly. Mobile device 57 may also be configured to provide services according to a subscription agreement with a third-party facility or wireless/telephone service provider. It should be appreciated that various service providers may utilize the wireless carrier system 14 and that the service provider of telematics unit 24 may not necessarily be the same as the service provider of mobile device 57. When using a short-range wireless connection (SRWC) protocol (e.g., Bluetooth Low Energy, Wi-Fi, etc.), mobile computing device 57 and telematics unit 24 may pair with each other (or link to one another) on a case-by-case basis and while within a wireless range; SRWC pairing is known to skilled artisans.

Data center 18 is designed to provide the vehicle hardware 20 with a number of different system backend functions and, according to the example shown here, generally includes one or more switches 52, servers 54, databases 56, advisors 58, one or more fleet managers, as well as a variety of other telecommunication/computer equipment 60. These various data center components are suitably coupled to one another via a network connection or bus 62, such as the one previously described in connection with the vehicle hardware 20. Switch 52, which can be a private branch exchange (PBX) switch, routes incoming signals so that voice transmissions are usually sent to either advisor 58, or an automated response system, and data transmissions are passed on to a modem or other piece of telecommunication/computer equipment 60 for demodulation and further signal processing. The modem or other telecommunication/computer equipment 60 may include an encoder, as previously explained, and can be connected to various devices such as a server 54 and database 56. Although the illustrated example has been described as it would be used in conjunction with a manned data center 18, it will be appreciated that the data center 18 can be any central or remote facility, manned or unmanned, mobile or fixed, to or from which it is desirable to exchange voice and data.

Server 54 can incorporate a data controller which essentially controls its operations. Server 54 may control data information as well as act as a transceiver to send and/or receive the data information (i.e., data transmissions) from one or more of the databases 56, telematics unit 24, and mobile computing device 57. The controller is moreover capable of reading executable instructions stored in a non-transitory machine readable medium and may include one or more from among a processor, microprocessor, central processing unit (CPU), graphics processor, Application Specific Integrated Circuits (ASICs), Field-Programmable Gate Arrays (FPGAs), state machines, and a combination of hardware, software, and firmware components.

Database 56 could be designed to store information in the form of executable instructions such as, but not limited to, one or more application program interface (API) suites 99. One API suite can be a web-mapping service that can generate virtual maps and route planning for the traveling of vehicle 12 (e.g., GOOGLE MAPS™). For example, using vehicle location data, the web-mapping suite 99 can transpose the location of vehicle 12 onto one or more of virtual maps. Moreover, the web-mapping suite 99 can establish one or more geofences onto the virtual maps (i.e., a virtual perimeter associated with a real-world geographic area laid out on the virtual maps). Moreover, web-mapping suite 99 can be configured to cause server 54 to send a signal when vehicle 12 is determined to enter into one of these geofences. As such, when the location of vehicle 12 is found to pass through a geographic boundary of one of the geofences, server 54 can send a trigger to vehicle 12 to cause the vehicle to somehow change its operations and/or behavior (discussed below).

### Method

The method or parts thereof can be implemented in a computer program product (e.g., processing device 38) embodied in a computer readable medium and including instructions usable by one or more processors of one or more computers of one or more systems to cause the system(s) to implement one or more of the method steps. The computer program product may include one or more software programs comprised of program instructions in source code, object code, executable code, or other formats; one or more firmware programs; or hardware description language (HDL) files; and any program related data. The data may include data structures, look-up tables, or data in any other suitable format. The program instructions may include program modules, routines, programs, objects, components, and/or the like. The computer program can be executed on one computer or on multiple computers in communication with one another.

The program(s) can be embodied on computer readable media, which can be non-transitory and can include one or more storage devices, articles of manufacture, or the like. Exemplary computer readable media include computer system memory, e.g. RAM (random access memory), ROM (read only memory); semiconductor memory, e.g. EPROM (erasable, programmable ROM), EEPROM (electrically erasable, programmable ROM), flash memory; magnetic or optical disks or tapes; and/or the like. The computer readable medium may also include computer to computer connections, for example, when data is transferred or provided over a network or another communications connection (either wired, wireless, or a combination thereof). Any combination(s) of the above examples is also included within the scope of the computer-readable media. It is therefore to be understood that the method can be at least partially performed by any electronic articles and/or devices capable of carrying out instructions corresponding to one or more steps of the disclosed method.

Turning now to FIGS. 4-7, there are shown embodiments of methods 400-700, each to exhibit a vehicle status to an environment surrounding vehicle 12 through the operation of antenna module 13. One or more aspects of these methods may be completed through telematics unit 24 which may include one or more executable instructions incorporated into memory device 40 and carried out by electronic processing device 38. One or more aspects of these methods may be completed through activation of the light(s) of antenna module 13. One or more ancillary aspects of these methods may be completed through mobile computing device 57 which may include one or more executable instructions incorporated into its mobile memory and carried out by its computer processing capability. One or more other ancillary aspects of these methods may be completed through data center 18 which may include one or more executable instructions incorporated into database 56 (e.g., web-mapping suite 99) and carried out by server 54. One or more ancillary aspects of method 200 may be completed through one or more buttons and/or controls 30 located in the vehicle's 12 interior.

These methods are supported by telematics unit 24 being configured to communicate with data center 18 and/or mobile computing device 57 over wireless carrier system 14. These configurations may be made by a vehicle manufacturer at or around the time of the telematics unit's assembly or after-market (e.g., via vehicle download using the afore-described communication system 10 or at a time of vehicle service, just to name a couple of examples).

With reference to FIG. 4, method 400 begins at 401 in which a vehicle owner/operator (system user) is at a location in proximity of vehicle 12. Moreover, the vehicle owner/operator has uncertainty as to the specific location of vehicle 12. In step 410, using mobile computing device 57, the vehicle owner will request that vehicle 12 provide its status to its surrounding environment (e.g., the parking lot, garage, driveway, etc.). In this instance, the vehicle 12 will indicate a status that it is parked at a safe location (i.e., it is not involved in an emergency situation) and it is also the vehicle owned and operated by the vehicle owner/operator. Moreover, to request that the vehicle provide its status from a remote location, the vehicle owner/operator may use a software application installed on mobile computing device 57 such as, for example, one of the MyBrand Apps (e.g., MyChevrolet App, MyBuick App, etc.) produced by GENERAL MOTORS™. Alternatively, the user may call data center 18 and speak with a live advisor 58 to have the live advisor 58 remotely activate vehicle 12 and have the vehicle 12 provide its status to its surrounding environment.

In step 420, the request is sent to data center 18 where it is verified, processed, and formatted to be wirelessly received and processed by telematics unit 24. Moreover, data center 18 will ensure that the signal sent to vehicle 12 will cause the light(s) 15 installed on antenna module 13 to generate the proper status indicator so as to exhibit the vehicle's location. As follows, the status indicator is a visual cue produced by an illumination of the light(s) 15, which is visible to nearby audiences in the vehicle environment (e.g., those within approximately ½ mile radius from vehicle 12) regardless of whether its daytime (and the vehicle environment is illuminated by daylight) or nighttime (and the vehicle environment is dark). In this step, in addition, data center 18 will transmit the properly formatted signal to vehicle 12. In this manner, data center 18 acts as a relay device necessary to ensure the correct signal is sent to vehicle 12.

In step 430, the signal is received by vehicle 12. Moreover, telematics unit 24 will cause the light(s) 15 of antenna module 13 to indicate the vehicle's location. For example, the light(s) 15 will illuminate and have a strobe effect (i.e., the lights are turned on and off in a unique pattern) to catch the eye of the vehicle owner/operator when indicating the vehicle's status. Moreover, the lights(s) may produce a white color to indicate the vehicle's location and that there are no safety concerns (i.e., it is ready for use) and, by the mere fact that light(s) illuminate, it is the vehicle tied to the vehicle owner/operator. After the light(s) 15 have been illuminated to generate a vehicle status indicator, method 400 moves to completion 402. It should be understood that, at least in this embodiment of method 400, after vehicle owner/operator arrives at vehicle and enters into the vehicle's cabin (e.g., by opening and closing one of the vehicle's doors), the light(s) may turn off and cease being illuminated to bring an end to the vehicle status indicator. It has also been envisioned that the vehicle 12 can supplement this vehicle status indicator from antenna module 13 with one or more honks from the vehicle's horn system.

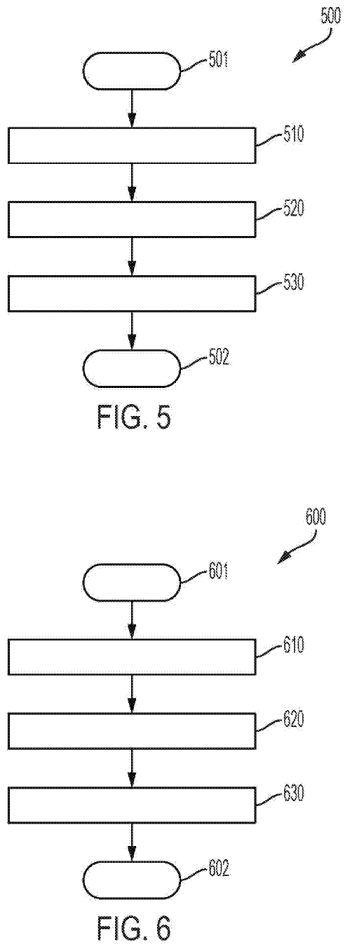

With reference to FIG. 5, method 500 begins at 501 in which vehicle 12 has been stolen and is being operated by a criminal (i.e., a car thief). In step 510, in one embodiment, the vehicle owner will provide information to data center 18 that vehicle 12 has been stolen. For example, the vehicle owner can call data center 18 using mobile computing device 57 to let a live advisor 58 know vehicle 12 has a stolen status. Alternatively, the vehicle owner can use a software application installed on mobile computing device 57 (e.g., the MyChevrolet App, MyBuick App, etc.) to electronically inform the data center 18 of the stolen status of vehicle 12. It should be understood that the vehicle owner's informing the data center 18 of vehicle 12 being stolen may somehow be in conjunction with the vehicle owner reporting the stolen vehicle status to law enforcement. In one or more alternative embodiments of step 510, law enforcement in pursuit of the fleeing stolen vehicle 12 may use mobile computing device 57 to call data center 18 to request the vehicle be remotely slowed down (e.g., via the OnStar's Stolen Vehicle Slowdown System—as is generally known in the art).

In step 520, data center 18 will generate a signal to be transmitted to vehicle 12 that will cause the light(s) 15 of antenna module 13 to generate a status indicator that exhibits vehicle 12 has been stolen. As follows, the status indicator is a visual cue produced by an illumination of the light(s) 15, which is visible to nearby audiences in the vehicle environment (e.g., those within a ½ mile radius from vehicle 12) regardless of whether its daytime (and the vehicle environment is illuminated by daylight) or nighttime (and the vehicle environment is dark). In this step, in addition, data center 18 will transmit the signal to vehicle 12.

In step 530, the signal is received by vehicle 12. Moreover, telematics unit 24 will cause the light(s) 15 of antenna module 13 to indicate vehicle 12 has been stolen. For example, the light(s) 15 will illuminate and have a strobe effect to catch the eye of the vehicle owner, law enforcement, or any other pedestrians or fellow drivers situated in proximity to vehicle 12. Moreover, the lights(s) may produce a red color to indicate the vehicle 12 has been stolen (and, when circumstance warrants it, vehicle 12 is being operated by a car thief). This status indicator can also aid law enforcement to track the vehicle 12 and its operator while attempting to escape. After light(s) 15 have been properly illuminated to generate this stolen vehicle status indicator, method 400 moves to completion 402. It should be understood that, at least in this embodiment of method 400, after vehicle owner or law enforcement gets back in contact with data center 18, the light(s) 15 can be turned off to bring an end to the vehicle status indicator. It has also been envisioned that the vehicle 12 can supplement this vehicle status indicator from antenna module 13 with one or more honks from the vehicle's horn system.

With reference to FIG. 6, method 600 begins at 601 in which vehicle 12 is involved in an emergency situation which requires the assistance of emergency responders (e.g., a vehicle-on-vehicle accident, the vehicle has become submerged in water, the vehicle has driven off of the roadway, etc.). In step 610, in one embodiment, one or more airbags of the vehicle is deployed in response to the emergency situation. Moreover, in this step, BCM 44 transmits an airbag deployment signal (an emergency signal) after the airbags have been deployed. In one or more alternative embodiments to step 610, a vehicle operator or vehicle passenger presses the one or more buttons and/or controls 30 in the vehicle's interior in response to the emergency situation. In response to the buttons and/or controls 30 being pressed, telematics unit 24 will transmit an emergency signal.

In step 620, the emergency signal is received by data center 18 where it is verified, processed, and formatted to be wirelessly received and processed by telematics unit 24. Moreover, data center 18 will ensure that the signal sent to vehicle 12 will cause the light(s) 15 installed on antenna module 13 to generate the proper status indicator so as to exhibit vehicle 12 is experiencing an emergency situation. As follows, the status indicator is a visual cue produced by an illumination of the light(s) 15, which is visible to nearby audiences in the vehicle environment regardless of the time of day. In this step, in addition, data center 18 will transmit the properly formatted signal to vehicle 12. In this manner, data center 18 acts as a relay device necessary to ensure the correct signal is sent to vehicle 12. It should also be understood that in alternative embodiments of method 600, an emergency signal is not sent to the remotely located data center 18 but is simply received by some other component within the vehicle electronics 20, for example, by telematics unit 24, antenna module 13, or some other VSM 44.

In step 630, the signal is received by telematics unit 24. Moreover, telematics unit 24 will cause the light(s) 15 of antenna module 13 to indicate vehicle 12 is undergoing an emergency situation and that help is required. For example, the light(s) 15 will illuminate and have a strobe effect to catch the eye of emergency responders or any other pedestrians or fellow drivers situated in proximity to vehicle 12. Moreover, the lights(s) may produce a yellow color to indicate the vehicle 12 as having an emergency situation status. This status indicator can also aid the emergency responder to finding/targeting the vehicle when it has been submerged in water or traveled off the roadway. This status indicator can also let nearby motorists know to steer clear of vehicle 12 or be careful because the vehicle environment could be hazardous. After the light(s) 15 have been properly illuminated to generate this emergency status indicator (safety status indicator), method 400 moves to completion 402. As mentioned above, antenna module 13 can house power source 19 such than when the emergency situation renders a power failure in vehicle 12, the light(s) 15 still illuminate to properly produce the vehicle status indicator. It is also understood that the vehicle status indicator may be produced in collaboration with an activation of the vehicle's hazard lights.

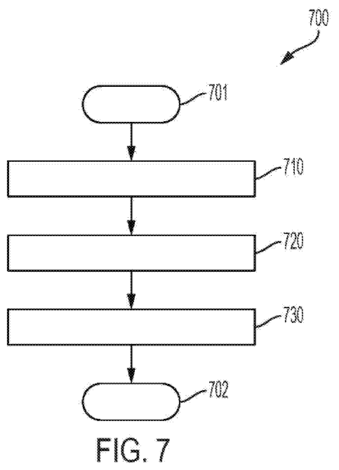

With reference to FIG. 7, method 700 begins at 701 in which vehicle 12 is an autonomous vehicle having known systems and components. Moreover, along a roadway one or more third-party motorists has been involved in some kind of vehicle accident situation (e.g., a flat tire, vehicle-to-vehicle collision, etc.). In step 710, in one or more embodiments, live advisor 58 will establish a geofence around the scene of the vehicle accident using the web-mapping suite 99. Moreover, vehicle 12 will be located within the geographic boundaries associated with the virtual geofence. In addition, in this step, vehicle 12 will transmit its location information to data center 18 (via the GPS component 42). In one or more alternative embodiments of step 710, vehicle 12 will be traveling autonomously near the scene of the vehicle accident. Moreover, one or more of the driving sensors on the exterior of vehicle 12 (e.g., one of the known lidar, radar, sonar, camera sensors used to help navigate autonomous vehicles) will sense evidence of the accident. For example, the driving sensors detect the hazard lights from a vehicle involved in the nearby accident. This sensed information is then sent to telematics unit 24, where one or more known object recognition techniques can be used to validate the contents of the sensed information. Upon validation, telematics unit 24 will transmit the sensed information to data center 18. In one or more alternative embodiments, vehicle 12 will be traveling autonomously near the scene of the vehicle accident. Moreover, one or more of the driving sensors on the exterior of vehicle 12 will sense evidence of the accident. This sensed information is then sent to data center 18 where a live advisor 58 can use the information to establish a geofence around the scene of the vehicle accident (via web-mapping suite 99). Vehicle 12 will also be located within the geographic boundaries associated with the virtual geofence and vehicle 12 will transmit its location information to data center 18 (via the GPS component 42). It should be understood that the other kinds of accident/hazardous situations can cause a geofence to be established or can be sensed by driving sensors. These situations can be natural (e.g., a tornado, hurricane, earth quake, etc.) or they can be man-made (e.g., chemical spill, airbag deployment in a third-party vehicle, some kind of violence occurring near the roadway, etc.).

In step 720, in one or more embodiments, the vehicle location information is received by data center 18. Data center 18 will then verify that the location of vehicle 12 falls within the geographic boundaries of the geofence. Moreover, data center 18 will generate a signal configured to be sent to vehicle 12 to cause the light(s) 15 to generate the proper status indicator so as to exhibit vehicle 12 is near an emergency situation. As follows, the status indicator is a visual cue produced by an illumination of the light(s) 15, which is visible to nearby audiences in the vehicle environment. Data center 18 may also couple this signal with a command to change the vehicle's driving path to move around the vehicle accident. In this step, in addition, data center 18 will transmit the properly formatted signal to vehicle 12 (which may be coupled with one or more driving commands). In this manner, data center 18 acts as a relay device necessary to ensure the correct signal is sent to vehicle 12. In one or more alternative embodiments of step 720, when the validated driving sensor sensed information is received by data center 18, data center 18 will generate the signal configured to be sent to vehicle 12 to cause the light(s) 15 to generate the proper status indicator. Data center 18 will also transmit the properly formatted signal to vehicle 12.

In step 730, the signal is received by telematics unit 24. Moreover, telematics unit 24 will cause the light(s) 15 of antenna module 13 to indicate vehicle 12 has the status of being near a potentially hazardous vehicle accident or coming from a potentially perilous driving environment. For example, the light(s) 15 will illuminate and produce a green color to indicate the vehicle 12 as being at a location that warrants cautious driving. This status indicator can also aid nearby motorists that they should drive carefully so as to avoid harm to themselves or someone involved in the vehicle accident. After the light(s) 15 have been properly illuminated to generate this hazardous environment status indicator (warning status indicator), method 400 moves to completion 402. It should be understood that the lights(s) 15 can be turned off to bring an end to the vehicle status indicator when vehicle 12 has passed beyond the designated geographic boundaries of the geofence. Alternatively, the lights(s) 15 can be turned off to bring an end to the vehicle status indicator when the vehicle's driving sensors stop sensing evidence of a vehicle accident. It should also be understood that the vehicle status indicator may be produced in collaboration with an activation of the vehicle's hazard lights.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for” in the claim.

1. A method to exhibit a vehicle status, the method comprising:
receiving a vehicle-status signal to indicate that the vehicle status be exhibited at a vehicle;
based on the vehicle-status signal, via a telematics unit installed in the vehicle, generating a vehicle status indicator that corresponds to a status of the vehicle, the vehicle status indicator being a visual cue visible in an environment surrounding the vehicle, wherein the vehicle status indicator is generated by an antenna module located on a portion of the vehicle; and
wherein the antenna module is an electronic device that comprises:
a housing;
one or more lights installed on an exterior portion of the housing, the one or more lights being operatively connected to the telematics unit, wherein the vehicle status indicator is provided via the one or more lights being illuminated; and
an independent power source located within the housing, the independent power source operatively connected to the one or more lights, the independent power source configured to automatically provide power to the one or more lights after the vehicle no longer provides power to the antenna module.

2. (canceled)

3. The method of claim 1, wherein the status of the vehicle corresponds to a color of the one or more lights while being illuminated.

4. The method of claim 1, wherein the vehicle is an autonomous vehicle, wherein the vehicle comprises one or more driving sensors configured to facilitate the autonomous navigation of the vehicle, wherein, when the one or more driving sensors detect evidence of a vehicle accident situation, the one or more driving sensors will transmit sensed information of the vehicle accident situation to the telematics unit, wherein the telematics unit will transmit the sensed information to a remote entity, wherein the remote entity will establish a virtual geofence around the vehicle accident situation, wherein, when the remote entity determines that the vehicle and/or one or more third-party vehicles are traveling within the boundaries of the virtual geofence, the remote entity will transmit the vehicle-status signal to the vehicle and/or the one or more third-party vehicles.

5. The method of claim 1, wherein the vehicle-status signal is provided by a button located in an interior of the vehicle.

6. The method of claim 1, wherein the vehicle-status signal is provided by a mobile computing device located remotely from the vehicle.

7. The method of claim 1, wherein the vehicle-status signal is provided by a remote facility after the remote facility receives information regarding the vehicle being stolen.

8. A system to exhibit a vehicle status, the system comprising:
an antenna module located on a portion of a vehicle; and
a memory configured to comprise one or more executable instructions and a processor configured to execute the executable instructions, wherein the memory and processor are located in a telematics unit installed in the vehicle, and wherein the executable instructions enable the processor to:
receive a vehicle-status signal to indicate that the vehicle status be exhibited at a vehicle;
based on the vehicle-status signal, generate a vehicle status indicator that corresponds to a status of the vehicle, the vehicle status indicator being a visual cue visible in an environment surrounding the vehicle, wherein the vehicle status indicator is generated by the antenna module; and
wherein the antenna module is an electronic device that comprises:
a housing;
one or more lights installed on an exterior portion of the housing, the one or more lights being operatively connected to the telematics unit, wherein the vehicle status indicator is provided via the one or more lights being illuminated; and
an independent power source located within the housing, the independent power source operatively connected to the one or more lights, the independent power source configured to automatically provide power to the one or more lights after the vehicle no longer provides power to the antenna module.

9. (canceled)

10. The system of claim 8, wherein the status of the vehicle corresponds to a color of the one or more lights while being illuminated.

11. The system of claim 8, wherein the vehicle is an autonomous vehicle, wherein the vehicle comprises one or more driving sensors configured to facilitate the autonomous navigation of the vehicle, wherein, when the one or more driving sensors detect evidence of a vehicle accident situation, the one or more driving sensors will transmit sensed information of the vehicle accident situation to the telematics unit, wherein the telematics unit will transmit the sensed information to a remote entity, wherein the remote entity will establish a virtual geofence around the vehicle accident situation, wherein, when the remote entity determines that the vehicle and/or one or more third-party vehicles are located within the boundaries of the virtual geofence, the remote entity will transmit the vehicle-status signal to the vehicle and/or the one or more third-party vehicles.

12. The system of claim 8, wherein the vehicle-status signal is provided by a button located in an interior of the vehicle.

13. The system of claim 8, wherein the vehicle-status signal is provided by a mobile computing device located remotely from the vehicle.

14. The system of claim 8, wherein the vehicle-status signal is provided by a remote facility after the remote facility receives information regarding the vehicle being stolen.

15. A non-transitory and machine-readable medium having stored thereon executable instructions adapted to exhibit a vehicle status, which when provided to a processor and executed thereby, causes the processor to:
receive a vehicle-status signal to indicate that the vehicle status be exhibited at a vehicle;
based on the vehicle-status signal, generate a vehicle status indicator that corresponds to a status of the vehicle, the vehicle status indicator being a visual cue visible in an environment surrounding the vehicle, wherein the vehicle status indicator is generated by an antenna module located on a portion of the vehicle;
wherein the non-transitory and machine-readable medium and processor are located in a telematics unit installed in the vehicle; and
wherein the antenna module is an electronic device that comprises:
a housing;
one or more lights installed on an exterior portion of the housing, the one or more lights being operatively connected to the telematics unit, wherein the vehicle status indicator is provided via the one or more lights being illuminated; and
an independent power source located within the housing, the independent power source operatively connected to the one or more lights, the independent power source configured to automatically provide power to the one or more lights after the vehicle no longer provides power to the antenna module.

16. (canceled)

17. The non-transitory and machine-readable medium of claim 15, wherein the status of the vehicle corresponds to a color of the one or more lights while being illuminated.

18. The non-transitory and machine-readable medium of claim 15, wherein the vehicle is an autonomous vehicle, wherein the vehicle comprises one or more driving sensors configured to facilitate the autonomous navigation of the vehicle, wherein, when the one or more driving sensors detect evidence of a vehicle accident situation, the one or more driving sensors will transmit sensed information of the vehicle accident situation to the telematics unit, wherein the telematics unit will transmit the sensed information to a remote entity, wherein the remote entity will establish a virtual geofence around the vehicle accident situation, wherein, when the remote entity determines that the vehicle and/or one or more third-party vehicles are located within the boundaries of the virtual geofence, the remote entity will transmit the vehicle-status signal to the vehicle and/or the one or more third-party vehicles.

19. The non-transitory and machine-readable medium of claim 15, wherein the vehicle-status signal is provided by a mobile computing device located remotely from the vehicle.

20. The non-transitory and machine-readable medium of claim 15, wherein the vehicle-status signal is provided by a remote facility after the remote facility receives information regarding the vehicle being stolen.
